(19) United States
(12) Patent Application Publication
(10) Pub. No.: US 2010/0122642 A1
(43) Pub. Date: May 20, 2010

(54) INKS INCLUDING CARBON NANOTUBES DISPERSED IN A POLYMER MATRIX

(75) Inventors: Valerie M. FARRUGIA, Oakville (CA); Yu QI, Oakville (CA); Paul J. GERROIR, Oakville (CA); Rosa M. DUQUE, Brampton (CA); Biritawit ASFAW, Oakville (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/272,347

(22) Filed: Nov. 17, 2008

(51) Int. Cl. C09D 11/12; C09D 11/08

(52) U.S. Cl. 106/31.29; 977/902

(57) ABSTRACT

An ink having a polymer matrix including carbon nanotubes dispersed in a polymer; optionally one or more colorants; and optionally one or more waxes.

### TECHNICAL FIELD OF THE DISCLOSURE

The present disclosure relates to inks comprising carbon nanotubes dispersed in a polymer matrix.

### BACKGROUND

Carbon nanotubes are unique carbon-based, molecular structures that exhibit excellent mechanical, thermal and electrical properties, thereby making them suitable for various applications. For instance, polymer composites containing carbon nanotubes have ⅙ the weight of steel, but are 50 to 100 or more times stronger than steel.

Two general types of carbon nanotubes exist: multi-walled carbon nanotubes (MWNTs) and single-walled carbon nanotubes (SWNTs). SWNTs have a cylindrical sheet-like, one-atom-thick shell of hexagonally-arranged carbon atoms, and carbon nanotubes are typically composed of multiple coaxial cylinders of ever-increasing diameter about a common axis. Thus, SWNTs can be considered to be the structure underlying carbon nanotubes and also carbon nanotube ropes, which are uniquely-arranged arrays of SWNTs. In the present disclosure, “multi-walled carbon nanotubes (MWNTs)” are also referred to as “carbon nanotubes (CNTs)” and “nanotubes.”

The formation of carbon nanotubes or nanofiber aggregates, which are microscopic particulate structures of nanotubes, is described in U.S. Pat. Nos. 5,165,909; 5,456,897; 5,707,916; 5,877,110; 5,110,693; 5,500,200 and 5,569,635, all of which are hereby entirely incorporated by reference.

Moreover, methods of manufacturing composites containing carbon nanotubes are known. For example, U.S. Pat. Nos. 5,643,502 and 6,299,812 describe carbon nanotubes that are physically, but not chemically, bonded to a polymer by using melt blowing and melt spinning. In these methods, monomer molecules are polymerized to form a polymer matrix. The carbon nanotubes are then added to the polymer matrix and mixed with polymer pellets, and the mixture is heated to a temperature greater than the melting point of the polymer. The liquefied mixture is extruded or spun, and then cooled to form a carbon nanotube/polymer composite.

Methods for cross-linking matrices of carbon nanotubes are described in U.S. Pat. No. 6,203,814. The carbon nanotubes are first functionalized, and then reacted with cross-linking agents to form porous cross-linked nanotubes.

Methods of chemically bonding carbon nanotubes to polymers are also known. Three main methods thereof include: 1) melt-mixing, 2) solution- or paranosolvent-mediated processes, and 3) in situ polymerization.

In situ polymerization involves directly functionalizing carbon nanotubes with one or more functional moieties, which promotes dispersion of carbon nanotubes in polymer matrices. For example, U.S. Patent Application Publication No. 2003/0089893 describes a polymer composite of carbon nanotubes chemically bonded to a polymer matrix. The carbon nanotubes are functionalized by attaching chemical moieties to the carbons on the surface of the carbon nanotubes. The carbon nanotube-attached functional moieties can react with selected monomers. The functionalized nanotubes are dispersed in an appropriate medium such as water, alcohol or a liquefied monomer. The monomers bind to the chemical moiety of the carbon nanotubes, and are polymerized to produce polymer chains bound to the surface carbons of the nanotubes. The resulting carbon nanotube/polymer composite may include some polymer chains imbedded therein that are not attached to the nanotubes.

In particular, inks containing carbon nanotube/polyester composite resins exhibit enhanced properties. Depending on the concentration of carbon nanotubes used, a composite resin can be made to have enhanced strength, stiffness, thermal stability, solvent resistance, glass transition temperature, electrical conductivity, reduced thermal shrinkage and optical anisotropy. Accordingly, adding carbon nanotube/polyester composite resins to inks render the inks suitable for use for a vast array of applications.

Additionally, as reported by Chiu et al., A Study of Carbon Nanotubes/Biodegradable Plastic Polylactic Acid Composites, J. App. Polymer Sci., 108:3024-30 (2008), adding carbon nanotubes to a polymer improves thermal properties. For example, adding unpurified nanotubes to the polymer improves the thermal decomposition of the MWNT/polymer matrix, and adding purified nanotubes imparts even greater improvement in the thermal decomposition. This is because the purified MWNTs enhance the attraction and interface effect in the polymer matrix.

Moreover, adding unpurified carbon nanotubes to a polymer increases the glass transition temperature, and adding purified carbon nanotubes imparts an even greater increase. The reason for this improvement is two-fold. First, adding the carbon nanotubes has a similar effect as adding a cross-linking agent, as intermolecular friction increases and the movement of macromolecular chains are restricted. Second, the decrease in free volume of the matrix accelerates phase separation and limits the motion of some molecular chains so that the dampening decreases. Adding purified carbon nanotubes increases the glass transition temperature more than adding unpurified carbon nanotubes because the purified carbon nanotubes can improve the compatibility with the polymer and achieve more uniform dispersion in the polymer.

### REFERENCES

Bhattacharyya et al., Crystallization and Orientation Studies in Polypropylene/Single Wall Carbon Nanotube Composite, Polymer, 44:2373-77 (2003) reports on studies of crystallization behavior of melt-blended polypropylene (PP)/single wall carbon nanotube composites using optical microscopy and differential scanning calorimetry.
Chiu et al., A Study of Carbon Nanotubes/Biodegradable Plastic Polylactic Acid Composites, J. App. Polymer Sci., 108:3024-30 (2008) analyzes the effect on mechanical properties imparted by adding various concentrations of CNTs to a polylactic acid matrix.
Kumar, Polymer/Carbon Nanotube Composites: Challenges and Opportunities, International Symposium on Nanostructured Polymeric Materials, Tokyo, Japan, held Dec. 4-5, 2003, describes that due to their exceptional mechanical, physical, thermal, optical and electrical properties, carbon nanotubes are dispersed in polymers using a variety of approaches. Specific property enhancement include strength, stiffness, thermal stability, solvent resistance, glass transition temperature, electrical conductivity, reduced thermal shrinkage and optical anisotropy.
Ryan et al., Carbon-Nanotube Nucleated Crystallinity in a Conjugated Polymer Based Composite, Chem. Phys. Letters, 391:329-33 (2004), discusses the that the presence of MWNTs induces crystallization of a semi-conjugated host polymer at the polymer-nanotube interface.
Tzavalas et al., Effect of Carboxy-Functionalized Multiwall Nanotubes (MWNT-COOH) on the Crystallization and Chain Conformations of Poly(ethylene terephthalate) PET in PET-MWNT Nanocomposites, Macromolecules, 39:9150-6 (2006) describes that adding acid-treated MWNTs to poly(ethylene terephthalate) (PET) increases the crystallinity of the PET and act as moderate nucleation agents.
Yu et al., The Characteristics of Carbon Nanotube Reinforced Poly(phenylene Sulphide) Nanocomposites, SIMTech Technical Reports, 8(2):71-5 (April-June 2007) describes that the electrical properties of poly(phenylene sulfide) (PPS) reinforced with MWNTs are dramatically enhanced at low loading level of nanotubes. The percolation threshold, a critical concentration of carbon nanotube filler where the resistivity starts to reduce abruptly, lies between 1 weight % and 2 weight % for PPS composites.

### SUMMARY

The present disclosure is directed to inks comprising carbon nanotube/polymer composite resins. Inks comprising carbon nanotube/polymer resins exhibit enhanced mechanical, chemical, thermal and electrical properties. Depending on the concentration of carbon nanotubes used, certain properties of the polymer resin may be altered. For example, when the carbon nanotube/polymer composite comprises carbon nanotubes from about 2% to about 20% by weight of the composite, the ink exhibits increased conductivity, and is thus suitable for conductive developing methods. Because carbon nanotubes have a high aspect ratio, only small amounts of carbon nanotubes need to be present in an ink in order to achieve the same conductivity as compared to conventional conductive additives. In another example, when the carbon nanotube/polymer composite comprises carbon nanotubes from about 0.05% to about 10% by weight of the polymer composite, the inks exhibit increased overall crystallinity. Finally, when the carbon nanotube/polymer composite comprises carbon nanotubes from about 2% to about 20% by weight of the polymer composite, the inks exhibit increased strength and scratch resistance. As the price of carbon nanotubes has dramatically decreased, the inks according to the present disclosure offer the advantages of being both cost-effective and exhibiting improved properties.

### EMBODIMENTS

The present disclosure provides an ink comprising a resin comprising a polymerized mixture, optionally one or more colorants and optionally one or more waxes, wherein the polymerized mixture is a composite comprising carbon nanotubes and a polymer. In some embodiments, the polymer is a polyester, and the ink is an inkjet ink.

The carbon nanotube/polymer composite according to the present disclosure is formed by known means in the art. The carbon nanotubes may be functionalized with one or more chemical moieties. The carbon nanotubes may be purified, if necessary, prior to functionalization. The chemical moiety on the carbon nanotubes generally covalently attach to a suitable monomer. The monomers then polymerize by any suitable means known in the art, thereby forming carbon nanotubes dispersed in a polymer matrix. This carbon nanotube/polymer composite resin can generally be incorporated into an ink.

This disclosure is not limited to particular embodiments described herein, and some components and processes may be varied by one of ordinary skill in the art, based on this disclosure. The terminology used herein is for the purpose of describing particular embodiments only, and is not intended to be limiting.

In this specification and the claims that follow, singular forms such as “a,” “an,” and “the” include plural forms unless the content clearly dictates otherwise.

In this specification and the claims that follow, “ink” is also referred to as “ink composition” and vice versa.

### Preparation for Nanotube Functionalization

The term “carbon nanotubes” refers to carbon tubes or fibers having very small diameters and includes fibrils, whiskers, buckytubes, and the like. Carbon nanotubes may be made with high purity and uniformity. Discrete nanotubes, aggregates of nanotubes, or both discrete and aggregate nanotubes may be suitable for use according to the present disclosure. In embodiments, the nanotubes of the present disclosure have a diameter less than 1 μm, such as less than about 0.5 μm, less than about 0.1 μm, or less than about 0.05 μm, although the amounts can be outside of these ranges.

Carbon nanotubes may be obtained from commercial sources, or synthesized by known methods. For example, U.S. Pat. No. 5,165,909, hereby entirely incorporated by reference, describes methods for making carbon fibrils. Examples of suitable carbon nanotube synthesis methods include chemical catalytic vapor deposition, arc discharge/laser ablation/HiPC®, and the like.

Prior to functionalization, the carbon nanotubes may be purified, if necessary, by any suitable means known in the art, such as the method described in U.S. Pat. No. 5,698,175, hereby incorporated entirely by reference. Generally, the carbon nanotubes are purified by reacting with one or more suitable reagents, such as oxidation agents, nitration agents and sulfonation agents in a liquid phase, followed by washing and drying. Purification dissolves metal particles and other impurities present on the carbon nanotubes. Examples of suitable agents for use in this process include, without limitation, hydrochloric acid, hydrofluoric acid, hydrobromic acid, hydroiodic acid, sulfuric acid, oleum, nitric acid, citric acid, oxalic acid, chlorosulfonic acid, phosphoric acid, trifluoromethane sulfonic acid, glacial acetic acid, monobasic organic acids, dibasic organic acids, potassium permanganate, persulfate, cerate, bromate, hydrogen peroxide, dichromate and mixtures thereof. Sulfuric acid, nitric acid, permanganate, chlorosulfonic acids and combinations thereof are particularly useful for this purpose due to the efficacy of the oxidation and functionalization. For example, treatment with 3M HNO₃ is very effective in dissolving metal particles. Also, because nitric acid is a strong oxidizer, amorphous carbon can be removed by oxidation. Additional means of purifying carbon nanotubes includes dispersing the nanotubes in a solvent, and optionally filtering and drying them before being contacted with a functionalizing agent.

### Functionalization of Carbon Nanotubes

The carbon nanotubes can be functionalized by any means known in the art. For example, U.S. Pat. Nos. 5,698,175 and 6,203,814 and U.S. Patent Application Publication No. 2006/0249711, hereby incorporated entirely by reference, describe methods for functionalizing carbon nanotubes. The functionalization results in one or more chemical moieties attached to the carbon nanotubes. The chemical functionalization promotes direct covalent coupling between the carbon nanotubes and the polyester matrix, and results in better dispersion of the nanotubes throughout the matrix and increased interaction of the nanotube surface groups with the polymer. It also results in improvement in crystallinity due to the effect of the nanotubes on the resulting morphology of a semicrystalline matrix. CNT act as nucleation sites to promote increase in polymer crystallinity.

Generally, functionalized carbon nanotubes can be directly prepared by sulfonation, electrophilic addition to deoxygenated carbon nanotube surfaces, metallation, oxidation, or other suitable means. In some embodiments, oxidation is carried out by acid-treatment, wherein oxidation chemistry may be used to open the end caps of both single and multi-walled nanotubes to produce carboxyl, carbonyl and hydroxyl groups at the opened ends and defects on the side walls. Oxidation of nanotubes provides both improved stability and the ability to form electrostatically stabilized colloidal dispersions in water and alcohols.

Functionalized nanotubes according to the present disclosure may generally have the following formula:

[CₙH_{L}—]Rₘ

wherein n is an integer, L is a number less than 0.1 n, m is a number less than 0.5 n;

R is selected from SO₃H, COOH, NH₂, OH, R′CHOH, CHO, CN, COCl, halide, COSH, SH, COOR′, SR′, SiR′₃, Si(—OR′—)_{y}R′_{3-y}, Si(O—SiR′₂)OR′, R″, Li, AIR′₂, Hg-X, TIZ₂, Mg-X, poly m-aminobenzoic sulfonic acid, polyimide, and polyvinyl alcohol, as well as amino acid derivatives, and the like;

y is an integer equal to or less than 3;

R′ is hydrogen, alkyl, aryl, cycloalkyl, or aralkyl, cycloaryl, or poly(alkylether);

R″ is fluoroalkyl, fluoroaryl, fluorocycloalkyl, fluoroaralkyl or cycloaryl;

X is halide; and

Z is carboxylate or trifluoroacetate.

Non-uniformly substituted nanotubes are also useful. These include compositions of the formula [CₙH_{L}—]Rₘ where n, L, m, R and the nanotube itself are as defined above, provided that R does not contain oxygen, or, if R is an oxygen-containing group, COOH is not present.

Also useful are the production of functionalized nanotubes having the formula [CₙH_{L}—][R′—]Rₘ where n, L, m, R′ and R have the same meaning as above. The carbon atoms, Cₙ, are surface carbons of a substantially cylindrical, carbon nanotube of a substantially constant diameter.

In some embodiments, the carbon nanotubes are functionalized with carboxylic acid moieties. Functionalization may be carried out, for example, via chlorate, nitric acid, or ammonium persulfate oxidation, and the like. Carboxylic acid-functionalized carbon nanotubes are particularly useful because they can serve as the starting point for preparing other types of functionalized carbon nanotubes. For example, alcohols or amides can be easily linked to the acid to give stable esters or amides. If the alcohol or amine is part of a di- or poly-functional molecule, then linkage through the O— or NH— leaves the other functionalities as pendant groups. These reactions can be carried out using any known methods for esterifying or aminating carboxylic acids with alcohols or amines. Amino groups can be introduced directly onto carbon nanotubes by treating the nanotubes with nitric acid and sulfuric acid to produce nitrated nanotubes, then reducing the nitrated nanotubes with a reducing agent, such as sodium dithionite, to produce amino-functionalized carbon nanotubes.

### Preparation of the Carbon Nanotube/Polymer Composite

To prepare the composites, the functionalized nanotubes are combined with a molar excess of a first monomer relative to the number of functional groups on the nanotubes. To do this, the functionalized nanotubes may be dispersed into a vehicle, such as water, an alcohol (e.g., ethylene glycol), or other liquid known in the art. The vehicle containing the functionalized carbon nanotubes is then combined with a first monomer. Alternatively, the functionalized carbon nanotubes may be directly combined with a molten or liquid first monomer.

The functionalized carbon nanotubes are dispersed in the first monomer. Dispersion may be implemented by use of ultrasonic sonicators or sonifiers or by use of other mechanical means such as a homogenizer, blender, mixer, and the like.

After dispersion, the functionalized carbon nanotubes are reacted with the first monomer to covalently attach the functional moieties on the carbon nanotubes to the first monomer. This may be done by any suitable means known in the art, such as by heating. Suitable heating methods include, but are not limited to, thermal heating, microwave heating, heat lamps, and combinations thereof. An excess of unreacted first monomer may be present in the product following the reaction.

Suitable first monomers that may be covalently attached to the functionalized nanotubes include, for example, diols having from 2 to 36 carbons, such as 1,8-octanediol, 1,9-nonanediol, 1,10-decanediol, 1,11-undecanediol, and 1,12-dodecanediol; polyamines such as ethylenediamine, pentamethylenediamine, hexamethylenediamine, diethylenetriamine, iminobispropylamine, phenylenediamine, xylylenediamine, and triethylenetetramine; aminocarboxylic acids such as 6-aminocaproic acid and ε-caprolactam; amino alcohols such as propanolamine; and the like.

Other suitable first monomers include, for example, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, Z,8-bis(hydroxymethyl)-tricyclo-[5.2.1.0]-decane wherein Z represents 3, 4, or 5; diols containing one or more oxygen atoms in the chain, such as, for example, ethylene glycol, diethylene glycol, triethylene glycol, dipropylene glycol, tripropylene glycol and the like; cycloaliphatic diols in their cis or trans configuration or as mixtures of both forms; 2-propane diol, 1,3-butanediol, neopentyl glycol, dibromoneopentyl glycol, 2,2,4-trimethylpentane-1,3-diol, pentanediol, hexanediol, 2,2-dimethylpropanediol, 2,2,3-trimethylhexanediol, heptanediol, dodecanediol, bis(hydroxyethyl)bisphenol A, bis(2-hyroxypropyl)-bisphenolA, xylenedimethanol, cyclohexanediol, bis(2-hydroxyethyl)oxide, dibutylene, 1,2-ethanediol, 1,5-pentanediol, 1,7-heptanediol; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like.

The functionalized carbon nanotubes covalently attached to a first monomer and any excess unreacted first monomer may be polymerized with a second monomer through the formation of ester or amide bonds to form a polymer matrix in which the carbon nanotubes are dispersed. Polymerization may generally be achieved by any known means in the art, such as by heating or via a bulk condensation reaction. The resultant polymer may be crystalline, semi-crystalline, amorphous, or a mixture thereof.

Suitable second monomers include, for example, organic acids, such as aliphatic, alicyclic, or aromatic dicarboxylic acids, 1,12-dodecananedioc acid, 1,4-cyclohexanedicarboxylic acid, 1,3-cyclohexanedicarboxylic acid, adipic acid, sebacic acid, 1,12-dodecanedioic acid, 2,6-naphthalenedicarboxylic acid, malonic acid, succinic acid, 2-methylsuccinic acid, 2,3-dimethylsuccinic acid, dodecylsuccinic acid, glutaric acid, adipic acid, 2-methyladipic acid, pimelic acid, azelaic acid, sebacic acid, terephthalic acid, isophthalic acid, phthalic acid, 1,2-cyclohexanedioic acid, 1,3-cyclohexanedioic acid, 1,4-cyclohexanedioic acid, glutaric anhydride, succinic anhydride, dodecylsuccinic anhydride, maleic anhydride, fumaric acid, maleic acid, itaconic acid, 2-methylitaconic acid; and dialkyl esters, wherein the alkyl groups are of one carbon chain to 23 carbon chain and are esters of malonate, succinate, 2-methyl succinate 2,3-dimethylsuccinate, dodecylsuccinate, glutarate, adipic acid, 2-methyladipate, pimelate, azeilate, sebacate acid, terephthalate, isophthalate, phthalate, 1,2-cyclohexanedioate, 1,3-cyclohexanedioate, and 1,4-cyclohexanedioate.

Other suitable second monomers may be, for example, dicarboxylic acids or diesters of dodecylsuccinic acid, dodecylsuccinic anhydride, suberic acid, dodecanediacid, dimethyl terephthalate, diethyl terephthalate, dimethylisophthalate, diethylisophthalate, dimethylphthalate, phthalicanhydride, diethylphthalate, dimethylsuccinate, dimethylfumarate, dimethylmaleate, dimethylglutarate, dimethyladipate, dimethyl dodecylsuccinate, oxalic acid, napthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassium salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbometh-oxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methyl-pentanediol, 2-sulfo-3,3-dimethylpentanediol, sulfo-p-hydroxybenzoic acid, N,N-bis(2-hydroxyethyl)-2-amino ethane sulfonate, or mixtures thereof.

The polymers formed from the polymerization of the second monomers may be, but are not limited to, polycarbonates, polyamides, polyesters and polyurethanes, the polyamide of adipic acid and hexamethylene diamine (nylon 6,6), poly(6-aminohexanoic acid) (nylon-6), the polyamide of meta-phthalic acid and meta-diaminobenzene (Nomex), the polyamide of para-phthalic acid and para-diaminobenzene (Kevlar), the polyester of dimethyl terephthalate and ethylene glycol (Dacron), the polycarbonate of carbonic acid, the polycarbonate of diethyl carbonate and bisphenol A (Lexan), the polyurethane of carbamic acid, the polyurethane of isocyanate and alcohol, the polyurethane of phenyl isocyanate with ethanol, the polyurethane of toluene diisocyanate and ethylene glycol.

Other suitable polymers include, for example, poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), copoly(5sulfoisophthaloyl)-copoly(ethylene-adipate), copoly(5-sulfoisophthaloyl)-copoly(propylene-adipate), copoly(5-sulfoisophthaloyl)-copoly(butylene-adipate), copoly(5-sulfo-isophthaloyl)-copoly(pentylene-adipate), copoly(5-sulfo-isophthaloyl)-copoly(hexylene-adipate), copoly(ethylene-sebacate)-copoly(ethylene-fumarate), copoly(ethylene-dodecanoate)-copoly(ethylene-fumarate), copoly(nonylene-sebacate)-copoly(nonylene-fumarate), copoly(nonylene-dodecanoate)-copoly(nonylene-fumarate), copoly(decylene-sebacate)-copoly(decylene-fumarate), copoly(decylene-dodecanoate)-copoly(decylene-fumarate), and copoly(butylene-fumarate)-copoly(hexylene-fumarate) and mixtures thereof.

Other suitable polymers include, for example, unsaturated polyester and/or its derivatives, including polyester resins and branched polyester resins, polyimide resins, branched polyimide resins, poly(styrene-acrylate) resins, crosslinked poly(styrene-acrylate) resins, poly(styrene-methacrylate) resins, crosslinked poly(styrene-methacrylate) resins, poly(styrene-butadiene) resins, crosslinked poly(styrene-butadiene) resins, alkali sulfonated-polyester resins, branched alkali sulfonated-polyester resins, alkali sulfonated-polyimide resins, branched alkali sulfonated-polyimide resins, alkali sulfonated poly(styrene-acrylate) resins, crosslinked alkali sulfonated poly(styrene-acrylate) resins, poly(styrene-methacrylate) resins, crosslinked alkali sulfonated-poly(styrene-methacrylate) resins, alkali sulfonated-poly(styrene-butadiene) resins, crosslinked alkali sulfonated poly(styrene-butadiene) resins, and crystalline polyester resins, poly(1,2-propylene-diethylene)terephthalate, polyethylene-terephthalate, polypropylene-terephthalate, polybutylene-terephthalate, polypentylene-terephthalate, polyhexylene-terephthalate, polyheptadene-terephthalate, polyoctalene-terephthalate, polyethylene-sebacate, polypropylene-sebacate, polybutylene-sebacate, polyethylene-adipate, polypropylene-adipate, polybutylene-adipate, polypentylene-adipate, polyhexylene-adipate polyheptadene-adipate, polyoctalene-adipate, polyethylene-glutarate, polypropylene-glutarate, polybutylene-glutarate, polypentylene-glutarate, polyhexylene-glutarate, polyheptadene-glutarate, polyoctalene-glutarate, polyethylene-pimelate, polypropylene-pimelate, polybutylene-pimelate, polypentylene-pimelate, polyhexylene-pimelate, polyheptadene-pimelate, poly(propoxylated bisphenol co-fumarate), poly(ethoxylated bisphenol co-fumarate), poly(butyloxylated bisphenol co-fumarate), poly(co-propoxylated bisphenol co ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co ethoxylated bisphenol co-itaconate), poly(1,2-propylene itaconate), or mixtures thereof.

Further still, the polymer may be a copolymer of any of eicosene and styrene; eicosene and undecylenyl halides; eicosene and undecylenyl alcohol; eicosene and undecylenyl acid; eicosene and alkali metal salts of undecylenyl acid; eicosene and alkyl and aryl undecylenic acid esters; eicosene and trialkylsilyl undecylenic acid esters; eicosene and iodo-eicosene; eicosene and quaternary ammonium undecylene; eicosene and amino undecylene; and eicosene and amido undecylene.

Moreover, the polymer may be styrene acrylates, styrene methacrylates, butadienes, isoprene, acrylonitrile, acrylic acid, methacrylic acid, beta-carboxy ethyl acrylate, polyesters, poly(styrene-butadiene), poly(methyl styrenebutadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, styrene/butyl acrylate/beta-carboxy ethyl acrylate terpolymers, PLIOTONE™ available from Goodyear, and mixtures thereof.

The carbon nanotube content of the carbon nanotube/polymer composite is generally from about 0.05% to about 20% by weight of the composite, such as from about 0.05% to about 5%, or from about 5% to about 15%, or from about 7% to about 10% by weight of the composite. In one embodiment, the carbon nanotube content is from about 0.5% to about 8% by weight of the composite.

### Carrier Material

The ink composition also includes a carrier material, or a mixture of two or more carrier materials. The carrier material can vary, for example, depending upon the specific type of ink composition. For example, an aqueous inkjet ink composition can use water, or a mixture of water and one or more other solvents, as a suitable carrier material. Other ink jet ink compositions can use one or more organic solvents as a carrier material, with or without water.

In the case of a solid (or phase change) inkjet ink composition, the carrier can include one or more organic compounds. The carrier for such solid ink compositions is typically solid at room temperature (about 20° C. to about 25° C.), but becomes liquid at the printer operating temperature for ejecting onto the print surface. Suitable carrier materials for solid ink compositions can thus include, for example, amides, including diamides, triamides, tetra-amides, and the like. Suitable triamides include, for example, those disclosed in U.S. Pat. No. 6,860,930, the entire disclosure of which is incorporated herein by reference. Other suitable amides, such as fatty amides including monoamides, tetra-amides, and mixtures thereof, are disclosed in, for example, U.S. Pat. Nos. 4,889,560, 4,889,761, 5,194,638, 4,830,671, 6,174,937, 5,372,852, 5,597,856, and 6,174,937, and British Patent No. GB 2 238 792, the entire disclosures of each are incorporated herein by reference. In embodiments where an amide is used as a carrier material, a triamide is particularly useful because triamides are believed to have structures that are more three-dimensional as compared to other amides such as diamides and tetraamides.

Other suitable carrier materials that can be used in the solid ink compositions include, for example, isocyanate-derived resins and waxes, such as urethane isocyanate-derived materials, urea isocyanate-derived materials, urethane/urea isocyanate-derived materials, mixtures thereof, and the like.

Additional suitable solid ink carrier materials include paraffins, microcrystalline waxes, polyethylene waxes, ester waxes, amide waxes, fatty acids, fatty alcohols, fatty amides and other waxy materials, sulfonamide materials, resinous materials made from different natural sources (such as, for example, tall oil rosins and rosin esters), and many synthetic resins, oligomers, polymers and copolymers, such as ethylene/vinyl acetate copolymers, ethylene/acrylic acid copolymers, ethylene/vinyl acetate/acrylic acid copolymers, copolymers of acrylic acid with polyamides, and the like, ionomers, and the like, as well as mixtures thereof. One or more of these materials can also be employed in a mixture with a fatty amide material and/or an isocyanate-derived material.

The ink carrier in a solid ink composition can be present in any desired or effective amount. For example, the carrier can be present in an amount of about 0.1 to about 99 weight percent, such as about 50 to about 98 weight percent, or about 90 to about 95 weight percent, although the amount can be outside of these ranges.

In the case of a radiation—(such as ultraviolet light-) curable ink composition, the ink composition comprises a carrier material that is typically a curable monomer, curable oligomer, or curable polymer, or a mixture thereof. The curable materials are typically liquid at 25° C. The curable ink composition can further include other curable materials, such as a curable wax or the like, in addition to the colorant and other additives described above. The term “curable” refers, for example, to the component or combination being polymerizable, that is, a material that may be cured via polymerization, including, for example, free radical routes, and/or in which polymerization is photoinitiated though use of a radiation sensitive photoinitiator. Thus, for example, the term “radiation curable” refers is intended to cover all forms of curing upon exposure to a radiation source, including light and heat sources and including in the presence or absence of initiators. Example radiation curing routes include, but are not limited to, curing using ultraviolet (UV) light, for example having a wavelength of 200-400 nm or more rarely visible light, such as in the presence of photoinitiators and/or sensitizers, curing using e-beam radiation, such as in the absence of photoinitiators, curing using thermal curing in the presence or absence of high temperature thermal initiators (and which are generally largely inactive at the jetting temperature), and appropriate combinations thereof.

Suitable radiation—(such as ultraviolet-) curable monomers and oligomers include, but are not limited to, acrylated esters, acrylated polyesters, acrylated ethers, acrylated polyethers, acrylated epoxies, urethane acrylates, and pentaerythritol tetraacrylate. Specific examples of suitable acrylated oligomers include, but are not limited to, acrylated polyester oligomers, such as CN2262 (Sartomer Co.), EB 812 (Cytec Surface Specialties), EB 810 (Cytec Surface Specialties), CN2200 (Sartomer Co.), CN2300 (Sartomer Co.), and the like, acrylated urethane oligomers, such as EB270 (UCB Chemicals), EB 5129 (Cytec Surface Specialties), CN2920 (Sartomer Co.), CN3211 (Sartomer Co.), and the like, and acrylated epoxy oligomers, such as EB 600 (Cytec Surface Specialties), EB 3411 (Cytec Surface Specialties), CN2204 (Sartomer Co.), CN110 (Sartomer Co.), and the like; and pentaerythritol tetraacrylate oligomers, such as SR399LV (Sartomer Co.) and the like. Specific examples of suitable acrylated monomers include, but are not limited to, polyacrylates, such as trimethylol propane triacrylate, pentaerythritol tetraacrylate, pentaerythritol triacrylate, dipentaerythritol pentaacrylate, glycerol propoxy triacrylate, tris(2-hydroxyethyl)isocyanurate triacrylate, pentaacrylate ester, and the like, epoxy acrylates, urethane acrylates, amine acrylates, acrylic acrylates, and the like. Mixtures of two or more materials can also be employed as the reactive monomer. Suitable reactive monomers are commercially available from, for example, Sartomer Co., Inc., Henkel Corp., Radcure Specialties, and the like. In embodiments, the at least one radiation curable oligomer and/or monomer can be cationically curable, radically curable, or the like.

The curable monomer or oligomer in embodiments is included in the ink in an amount of, for example, about 20 to about 90 weight percent of the ink, such as about 30 to about 85 weight percent, or about 40 to about 80 weight percent, although the amount can be outside of these ranges. In embodiments, the curable monomer or oligomer has a viscosity at 25° C. of about 1 to about 50 cP, such as about 1 to about 40 cP or about 10 to about 30 cP, although the amount can be outside of these ranges. In one embodiment, the curable monomer or oligomer has a viscosity at 25° C. of about 20 cP. Also, in some embodiments, it is desired that the curable monomer or oligomer is not a skin irritant, so that printed images using the ink compositions are not irritable to users.

In other embodiments, the ink composition which comprises an aqueous liquid vehicle and the magnetic single crystal nanoparticles disclosed herein. The liquid vehicle can consist solely of water, or it can comprise a mixture of water and a water soluble or water miscible organic component, such as ethylene glycol, propylene glycol, diethylene glycols, glycerine, dipropylene glycols, polyethylene glycols, polypropylene glycols, amides, ethers, urea, substituted ureas, carboxylic acids and their salts, esters, alcohols, organosulfides, organosulfoxides, sulfones (such as sulfolane), alcohol derivatives, carbitol, butyl carbitol, cellusolve, tripropylene glycol monomethyl ether, ether derivatives, amino alcohols, ketones, N-methylpyrrolidinone, 2-pyrrolidinone, cyclohexylpyrrolidone, hydroxyethers, amides, sulfoxides, lactones, polyelectrolytes, methyl sulfonylethanol, imidazole, betaine, and other water soluble or water miscible materials, as well as mixtures thereof.

In other embodiments encompassing non-aqueous inks, the magnetic single crystal nanoparticles can be used in solvent-borne inks such as petroleum-based inks that include aliphatic hydrocarbons, aromatic hydrocarbons, and mixtures thereof, environmentally friendly soy and vegetable oil-based inks, linseed oil-based inks and other ink-based vehicles derived from natural sources. Other examples of ink vehicles for magnetic single crystal nanoparticles include isophthalic alkyds, higher order alcohols and the like. In still other embodiments, the magnetic single crystal nanoparticles can be applied towards inks used in relief, gravure, stencil, and lithographic printing.

### Colorants

The ink compositions may be produced as a colored ink by adding a colorant during ink production. Any desired or effective colorant can be employed in the ink compositions, including pigment, dye, mixtures of pigment and dye, mixtures of pigments, mixtures of dyes, and the like. The carbon nanotubes/polymer resins may also, in embodiments, impart some or all of the colorant properties to the ink compositions.

Suitable colorants for use in the ink compositions include, without limitation, carbon black, lamp black, iron black, ultramarine, Nigrosine dye, Aniline Blue, Du Pont Oil Red, Quinoline Yellow, Methylene Blue Chloride, Phthalocyanine Blue, Phthalocyanine Green, Rhodamine 6C Lake, Chrome Yellow, quinacridone, Benzidine Yellow, Malachite Green, Hansa Yellow G, Malachite Green hexalate, oil black, azo oil black, Rose Bengale, monoazo pigments, disazo pigments, trisazo pigments, tertiary ammonium salts, metallic salts of salicylic acid and salicylic acid derivatives, Fast Yellow G, Hansa Brilliant Yellow 5GX, Disazo Yellow AAA, Naphthol Red HFG, Lake Red C, Benzimidazolone Carmine HF3C, Dioxazine Violet, Benzimidazolone Brown HFR, Aniline Black, titanium oxide, Tartrazine Lake, Rhodamine 6G Lake, Methyl Violet Lake, Basic 6G Lake, Brilliant Green lakes, Hansa Yellow, Naphtol Yellow, Watching Red, Rhodamine B, Methylene Blue, Victoria Blue, Ultramarine Blue, and the like.

The amount of colorant can vary over a wide range, for instance, from about 3 to about 20 weight percent of the ink weight, and combinations of colorants may be used.

### Waxes

One or more waxes may be added to the ink in order to raise the image density and to effectively prevent the offset to a reading head and the image smearing. The wax can be present in an amount of, for example, from about 0.1 to about 10 percent weight, such as in an amount of from about 1 to about 6 percent weight based on the total weight of the ink, although the amounts can be outside of these ranges. Examples of suitable waxes include, but are not limited to, polyolefin waxes, such as low molecular weight polyethylene, polypropylene, a fluorocarbon-based wax (Teflon), or Fischer-Tropsch wax, copolymers thereof, mixtures thereof, and the like.

### Surfactants

Examples of nonionic surfactants that may be used in the ink according to the present disclosure include, without limitation, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy)ethanol, mixtures thereof, and the like.

Examples of suitable cationic surfactants include, without limitation, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇-trimethyl ammonium bromides, halide salts of quaternized polyoxyethylalkylamines, dodecylbenzyl triethyl ammonium chloride, mixtures thereof, and the like.

A suitable amount of surfactant can be selected, such as in an amount of about 0.1 to about 10 percent weight of the ink weight, such as about 0.2 to about 5 percent weight, although the amounts can be outside of these ranges. The choice of particular surfactants, or combinations thereof, as well as the amounts of each to be used are within the purview of those skilled in the art.

Further, olefin-maleic acid, anhydride copolymer, and the like, may be added to obtain ink images having high quality without deterioration of developing property.

### Antioxidants

The ink may also optionally contain an antioxidant. Antioxidants protect the images from oxidation and also protect the ink components from oxidation during the heating portion of the ink preparation process. Specific examples of suitable antioxidants include NAUGUARD® series of antioxidants, such as NAUGUARD® 445, NAUGUARD® 524, NAUGUARD® 76, and NAUGUARD® 512 (commercially available from Uniroyal Chemical Company), the IRGANOX® series of antioxidants such as IRGANOX® 1010 (commercially available from Ciba Geigy), and the like. The antioxidant may be present in the ink in any desired or effective amount, such as in an amount of from at least about 0.01 to about 20 percent weight of the total ink weight, such as about 0.1 to about 5 percent weight of the ink weight or from about 1 to about 3 percent weight of the ink weight, although the amount may be outside of these ranges.

### Clarifiers

Clarifiers may also be optionally added to the ink, such as UNION CAMP® X37-523-235 (commercially available from Union Camp); tackifiers, such as FORAL® 85, a glycerol ester of hydrogenated abietic (rosin) acid (commercially available from Hercules), FORAL® 105, a pentaerythritol ester of hydroabietic (rosin) acid (commercially available from Hercules), CELLOLYN® 21, a hydroabietic (rosin) alcohol ester of phthalic acid (commercially available from Hercules), ARAKAWA KE-311 Resin, a triglyceride of hydrogenated abietic (rosin) acid (commercially available from Arakawa Chemical Industries, Ltd.), synthetic polyterpene resins such as NEVTAC® 2300, NEVTAC® 100, and NEVTAC® 80 (commercially available from Neville Chemical Company), WINGTACK® 86, a modified synthetic polyterpene resin (commercially available from Goodyear), and the like; adhesives, such as VERSAMID® 757, 759, or 744 (commercially available from Henkel), plasticizers, such as UNIPLEX® 250 (commercially available from Uniplex), the phthalate ester plasticizers commercially available from Monsanto under the trade name SANTICIZER®, such as dioctyl phthalate, diundecyl phthalate, alkylbenzyl phthalate (SANTICIZER® 278), triphenyl phosphate (commercially available from Monsanto), KP-140°, a tributoxyethyl phosphate (commercially available from FMC Corporation), MORFLEX® 150, a dicyclohexyl phthalate (commercially available from Morflex Chemical Company Inc.), trioctyl trimellitate (commercially available from Eastman Kodak Co.), and the like. Such additives may be included in conventional amounts for their usual purposes.

### Additional Additives

The ink may further contain one or more additives for their known purposes. For example, suitable additives include a fluidization agent such as colloidal silica; lubricants such as metal salts of fatty acids; silica; a spacing agent; a dryer; a dispersant; a humectant; a stabilizer; a thickening agent; a gelatinizing agent; a defoaming agent and an initiator for photopolymerization.

### Preparation of Ink

The ink composition of the present disclosure can be prepared by any desired or suitable method. For example, in the case of solid or phase change inks, or even curable inks, the ink ingredients can be mixed together, followed by heating, typically to a temperature of from about 100° C. to about 140° C., although the temperature can be outside of this range, and stirring until a homogeneous ink composition is obtained, followed by cooling the ink to ambient temperature (typically from about 20° C. to about 25° C.). In the case of liquid ink compositions, the ink ingredients can simply be mixed together with stirring to provide a homogeneous composition, although heating can also be used if desired or necessary to help form the composition. Other methods for making ink compositions are known in the art and will be apparent based on the present disclosure.

The ink according to the present disclosure may be, for example, an aqueous ink, an oil, ink, a curable ink, a solid ink, or a hot-melt ink.

The ink may be produced by any known method blending the above mentioned components, melting with kneading the mixture and pulverizing the resultant mass. Moreover, it may be produced by a polymerization method which comprises blending monomers for the binder with other ingredients and polymerizing the mixture.

### Printing of the Ink

The magnetic metal particle ink may generally be printed on a suitable substrate such as, without limitation, paper, glass art paper, bond paper, paperboard, Kraft paper, cardboard, semi-synthetic paper or plastic sheets, such as polyester or polyethylene sheets, and the like. These various substrates can be provided in their natural state, such as uncoated paper, or they can be provided in modified forms, such as coated or treated papers or cardboard, printed papers or cardboard, and the like.

For printing the ink on a substrate, any suitable printing method may be used. For example, suitable methods include, without limitation, roll-to-roll high volume analog printing methods, such as gravure, rotogravure, flexography, lithography, etching, screenprinting, and the like. Additionally, thermography, electrophotography, electrography, laser induced transfer, inkjet printing, or a combination thereof may be used. If a laser induced transfer digital printing method is used, exemplary methods of such method are dye sublimination, ablation, melt transfer, or film transfer. The ink may also be used for a thermal transfer printer, a hot-melt printer and ordinary instrument for writing. In a particular embodiment, the method used is inkjet printing.

### Applications of the Ink

A variety of possible application of the ink produced by the present disclosure exists. The ink may generally be used for developing electrostatic latent image formed by electrographotography, electrostatic recording, iconography, xerography, MICR applications, RFID applications and the like. Moreover, the ink may be used for other suitable applications.

### EXAMPLES

Example 1 describes the functionalization of carbon nanotubes. Examples 2 and 3 describe the synthesis of carbon nanotubes/semi-crystalline polyester resin compositions using the process described in Example 1, except that different amounts of the carbon nanotubes were used. Comparative Examples 1 and 2 describe preparing the resin composition according Examples 2 and 3, respectively, except that functionalized carbon nanotubes were omitted.

### Example 1

### Preparation of Carboxylic Acid-Functionalized MWNTs Using Nitric Acid, Hydrochloric Acid and Air Oxidation (Sample ID VF564)

MWNTs were purified in a three-step process. In the first step, 5.0 g of MWNTs were treated with 3 M HNO₃ via reflux process for 24 hr and 47 min at 60° C. 745 g of 3 M HNO₃ solution (201.15 g of 70% nitric acid and 543.85 g of distilled water) was added to the 5.0 g of MWNTs (Sigma-Aldrich), and were allowed to react for 24 hours. Next, the MWNTs/acid mixture was diluted with deionized water, and centrifuged for 1 hour at 3000 g. The MWNT pellet was resuspended in deionized water. After a second round of resuspension in deionized water, followed by centrifugation for 1 hour at 3000 g, the pH of the solution was pH 0.26. Following another wash, the pH of the solution was 1.50. Following another wash, the solution had a pH of 1.84.

In the second step, the MWNTs were further treated with HCl to dissolve metal oxides. A 5 M HCl solution was prepared by adding 367.06 g of 37% hydrochloric acid to 377.94 g distilled water. The molarity of the HCl solution was diluted a bit because rinsing water was needed to get the carbon nanotubes into the flask. A reflux system was set up with an overpressure valve connected to the Schlenk line to allow expansion of the media and avoid explosions. The reflux ran for 7 hours at 120° C., and produced relatively pure MWNTs suspended in HCl. The MWNTs were isolated from the HCl solution via centrifugation for 1 hour at 3000 g.

Subsequently, the MWNTs were washed three times, and produced a solution with a pH of 1.58. After redispersing in deionized water and centrifuging and for an additional 1.5 hours at 3000 g, the pH was 2.53. After redispersing in deionized water and centrifuging for another 1.5 hours at 3000 g, the pH was 3.01. The MWNTs were redispersed in water and centrifuged at 3000 g for 1.5 hours. The pH was 3.59 and no further washing was done. The MWNTs were then dispersed in 10 ml deionized water and placed in an oven in order to evaporate off water.

In the third step of the purification, air oxidation was performed, in which MWNTs were purified by burning off acid-treated materials. MWNTs and non-nanotubes have different oxidation temperatures. 510° C. is an optimum temperature to burn out non-nanotube carbon materials, as the weight of carbon nanotubes remains unchanged from 510° C. to 645° C. 4.6965 g of unpurified MWNTs were combusted in air at 510° C. for 1 hour. Non-nanotube impurities were burned off, leaving 3.258 g of purified MWNTs, or a 69.67% yield.

### Example 2

### Preparation of 2% MWNTs/Polyester Composite (Sample ID VF566)

A 500 g quantity of 1,9-nonanediol is transferred into a 3 L reaction kettle reactor and melt mixed to 60° C. on a hot plate with occasional stirring. About 21.6 g of MWNTs produced in Example 1 (2% relative to 1080 g polymer theoretical yield) is added to the molten 1,9-nonanediol. After the MWNTs are well-dispersed in the diol (and possibly esterificated), the glass reaction kettle is removed from the hot plate, and 719 g of 1,12-dodecanedioic acid and 1.30 g Fascat 4100 catalyst are added to the reactor. The kettle is then transferred to the heating mantle. The heating mantle air flow, the Argon purge, heater electrical box, Lauda condenser oil bath and water condenser are turned on. The stirrer is turned on as soon as the mixture starts to melt; the kettle and bottom of hot condenser are wrapped with Kim towels and foil wrapped to retain heat. The reagents start melting around 80° C. and the reaction proceeds. The temperature is increased to 170° C. over 60 minutes and is maintained at 170° C. for 5 hours. The reaction is blanketed with argon and held at 120° C. overnight.

The next day, approximately 85 ml of condensed water is collected in a graduated cylinder. Low vacuum is applied using a small lab vacuum (grey standard) for about 27 min. Both cold and hot condensers are left on during this step. The total water yield increases to about 95 ml through the use of the vacuum pump. Both condensers are removed. Argon is purged through the system at 170° C. Sampling proceeds before Edwards High vacuum is applied. The viscosity is 2.64 Pa Sec. The reaction is blanketed with argon and held at 120° C. overnight.

The following day, the temperature is increased to 170° C. over 30 min. Sampling proceeds before Edwards High vacuum is applied. Viscosity is 8.85 Pa sec. The reaction is heated without vacuum until the viscosity reaches about 11 Pa sec. The resin is cooled to about 170° C. before discharging out via pouring by hand. The resin is cooled in a pan, broken down and then crushed in a delumper apparatus. A sample of the resin was submitted for acid value, GPC, DSC, viscosity and ICP (Sn). The final viscosity is 12.4 Pa sec at 11.7γ. The acid value is 10.2 mg KOH/g.

### Example 3

### Preparation of 7% MWNTs/Polyester Composite (Sample ID VF567)

A 500 g quantity of 1,9-nonanediol is transferred into a 3 L glass reaction kettle and melt mixed to 60° C. with occasional stirring. About 75.6 g of MWNTs (7% relative to 1080 g polymer mass) is added to the molten nonanediol. After the carbon nanotube are well-dispersed in the diol (and possibly esterificated), the glass reactor is removed from the hot plate. 719 g of 1,12-dodecanedioic acid and 1.30 g of Fascat 4100 catalyst are added to the reactor. The kettle is then transferred to the heating mantle. The heating mantle air flow is turned on, along with the Argon purge, heater electrical box, Lauda condenser bath and water condenser. The stirrer is turned on as soon as the mixture starts to melt; the kettle and the bottom of the hot condenser are wrapped with Kim towels and foil to insulate the system. The reagents start melting around 80° C. and reaction proceeds. The temperature is increased to 170° C. over 60 minutes and held there for 6 hours. While blanketing the reaction under argon, the reaction is held at 120° C. overnight.

Overnight, about 42 ml of water is condensed and collected in graduated cylinder. The temperature is brought back up from 120° C. to 170° C. Low vacuum is applied using the small lab vacuum (grey standard) for about 30 minutes. Both cold and hot condensers are left on during this step. Still at 170° C., the graduated cylinder is attached to an adapter with a vacuum line to pull more water/glycol, and the total water/glycol yield increases to about 51 ml. Both condensers are removed. Argon is purged through the system at 170° C. The Edwards high vacuum is applied for the first 193 minutes; at 357 min the viscosity is 26.6 Pa sec. The run is stopped at 380 minutes. The resin is discharged out via pouring by hand. The resin is cooled in a pan, broken down and then crushed in a delumper apparatus. A sample of the resin is submitted for acid value, GPC, DSC, viscosity and ICP (Sn). The final viscosity is 35 Pa sec at 11.7γ. The acid value is 7.59 mg KOH/g.

### Comparative Example 1

### Preparation of Nominal Resin Containing No Carbon Nanotube (Sample ID VF568)

A 719 gram quantity of 1,12-dodecanedioc acid monomer, 500 gram of 1,9-nonanediol monomer and 1.303 g Fascat 4100 catalyst were all weighed out into a 3 L glass reaction kettle. The kettle was then transferred to the heating mantle. The heating mantle air flow was turned on, along with the argon purge, heater electrical box, Lauda condenser bath and water condenser. The stirrer was turned on as soon as the mixture started to melt; the kettle and the bottom of the hot condenser were wrapped with Kim towels and foil to insulate the system. The reagents started melting around 80° C.; the temperature was increased to 170° C. over 60 minutes and held there for 5 hours. About 45 ml of water condensed and was collected in graduated cylinder. While blanketing the reaction under argon, temperature was dropped to 120° C. until the next day.

The next day, the temperature was increased from 120° C. to 170° C. A graduated cylinder was attached to an adapter with a vacuum line to pull more water off. Low vacuum was applied using a small lab vacuum (grey standard) for about 34 min. Both cold and hot condensers were left on during this step. The total water condensate yield increased to about 50 ml using the vacuum pump. Both condensers were removed. Argon was purged through the system at 170° C. The Edwards High vacuum was applied. Viscosity was checked at 257 minutes at 170° C., and was 6.9 Pa Sec. At 323 minutes, the reaction was stopped. The resin was discharged at 170° C. via pouring by hand. The resin was cooled in a pan, broken down and then crushed in a delumper apparatus. A sample of the resin was submitted for acid value, GPC, DSC, viscosity and ICP (Sn). The final viscosity was 13.5 Pa sec at 11.7γ. The acid value was 9.99 mg KOH/g.

### Comparative Example 2

### Preparation of Nominal Resin Containing No Carbon Nanotube (Sample ID VF559)

A 719 gram quantity of 1,12-dodecanedioc acid monomer, 500 gram 1,9-nonanediol and 1.303 gram Fascat 4100 catalyst were weighed out into a 3 L glass reaction kettle. The heating mantle air flow was turned on, along with the nitrogen purge, heater electrical box, Lauda condenser bath and water condenser. The stirrer was turned on as soon as the mixture started melting; the kettle and the bottom of the hot condenser were wrapped with Kim towels and foil to insulate the system. Reagents started melting around 80° C.; the temperature was first increased to 165° C. over 90 minutes and held there for 2 hours. Next, the temperature was further increased to 190° C. over 60 minutes and held there for 5 hours. About 35 ml of water condensed and was collected in graduated cylinder. While blanketing the reaction under nitrogen, the temperature was dropped to 120° C. until the next day.

Next day, the temperature was increased to 190° C. over 60 minutes. Both cold and hot condensers were left on during this step. At 190° C., the graduated cylinder was attached to an adapter with a vacuum line to pull more water off. Low vacuum was applied using the small lab vacuum (grey standard) for about 20 minutes. The total water distillate yield increased to 50 ml with help of the vacuum pump. The vacuum system was switched to the Edwards High vacuum system and both condensers were removed. Vacuum and heat were applied to the system most of the day and viscosity of the resin reached about 12.55 Pa sec.

On the third day, the system was reheated to 190° C. and vacuum was applied. After 45 minutes the viscosity was 32.5 Pa sec and the heat was turned off. The resin was cooled to about 170° C. before discharging out via pouring by hand. The resin was cooled in a pan, broken down and then crushed in a delumper apparatus. A sample of the resin was submitted for acid value, GPC, DSC, viscosity and ICP (Sn). The final viscosity was 42.7 Pa sec at 11.7 γ. The acid value was 8.11 mg KOH/g.

### Preparation of Controls

A crystalline polyester control (Sample ID VF568) and Sample ID VF567 containing 0.075% MWNTs were heated on a Linkam Hot Stage, model LTS350 with observations being made using a Zeiss Axioplan polarizing microscope. Both samples were heated at 10° C./min to 120° C., and then held at that temperature for 5 minutes before being cooled at 3° C./min to 40° C. Micrographs of the cooled, recrystallized materials were acquired using cross-polarized light on the Zeiss microscopy. The crystalline spherulites of pure crystalline polyester were larger in size, but after the addition of the carbon nanotubes, the size was significantly reduced. The reduced size of the crystalline domain suggest that more nucleating sites were available for growth, thereby attributing to the subsequent increase in the overall crystallinity of the sample.

### The Effect of MWNTs on Recrystallization

Table 1 shows MWNT/crystalline polyester composite differential scanning calorimeter (DSC) and Percent Change in Recrystallization Data. DSC is a good tool for measuring changes in crystallinity in polymers. The % change in recrystallization is calculated by subtracting the ΔH (2^{nd} melt Tₘ) of carbon nanotube/crystalline polyester composites from the control, then dividing the difference by the control ΔH (2^{nd} melt Tₘ) and multiplying by 100. The results verify that synthesizing carbon nanotube/crystalline polyester composites increases the amount of crystallinity in the polymer. If the polymer could be obtained in 100% crystalline form, ΔH_{f} (heat of fusion) could be measured, but all crystalline polymers are semicrystalline. Moreover, other methods for determining ΔH_{f} exist such as spectroscopic methods, X-ray or nuclear magnetic resonance that requires normalization of peaks (which is very tedious and potentially complicated), and a DSC performed on a sample with known fraction crystallinity (but this can also be difficult to apply to polymers). Here, the total % crystallinity of the samples was not calculated; only the change in crystallinity of carbon nanotube/crystalline polyester composites compared to the control or non-carbon nanotube containing crystalline polyester was calculated.

TABLE 1
CPE/MWNT Composite DSC and % Change in Recrystallization Data

| ID/Type of Crystalline | Wt-% of | | | Tₘ (° C.) | ΔH (J/g) for | % Change in |
|---|---|---|---|---|---|---|
| Polyester (CPE) | MWNT | Tₘ (° C.) | T_{rc} (° C.) | 2^{nd} melt | 2^{nd} melt Tₘ | Recrystallization |
| VF568 (CPE control); | 0% | 76.61 | 56.60 | 74.01 | 126.1 | +5.00% |
| η = 12.4 Pa · sec | | | | | | |
| VF566 (with MWNT); | 0.075% | 75.44 | 58.78 | 73.19 | 132.4 | |
| η = 13.5 Pa · sec | | | | | | |
| VF559 (CPE control); | 0% | 75.42 | 58.44 | 72.93 | 120.0 | +4.46% |
| η = 35.0 Pa · sec | | | | | | |
| VF567 (with MWNT); | 0.185% | 76.44 | 59.20 | 73.66 | 125.6 | |
| η = 42.7 Pa · sec | | | | | | |

The results shown in Table 1, specifically the % change in recrystallization, suggest that the carbon nanotubes act as nucleating agents in these crystalline polyester resins. The difference in the melting points of the neat crystalline polyester from the carbon nanotube/crystalline polyester samples shows a relative percentage increase in crystallinity of about 5%. The concentration of carbon nanotube loading in the sample crystalline polyester is really low and does not show a significant difference between 0.075% and 0.185%, but generally will show a significant increase in crystallinity at loadings over 0.3%. Moreover, the crystallinity can decrease again when the MWNT concentration is about or exceeds 10%, due to the MWNTs hindering the molecular movement in the polymer matrix in the molten state, which caused a reduction of the polymer crystallization rate, as reported by Yu et al.; Bhattacharyya et al.; Tzavalas et al.; Kumar; and Ryan et al. Also as previously reported in literature, in other polymers, such as isotactic polypropylene, the induction time for crystallization is reduced by the addition of carbon nanotube and typically Tₘ is shifted to higher temperatures in the presence of carbon nanotubes. This supports the conclusion that carbon nanotubes act as nucleating agents in these polymeric systems.

### The Effect of MWNTs on Mechanical Properties

Each of the composites prepared in Examples 1-3 can be incorporated into inks according to suitable means known in the art.

Table 2 compares the Young's modulus and hardness of inks comprising crystalline polyester resin composites having various carbon nanotube loadings. Inks comprising a crystalline polyester resin composites having carbon nanotube loadings as low as 2% show dramatic improvement Young's Modulus and hardness. The increase in strength imparts increase in scratch resistance in the ink, thereby yielding better ink performance with relatively little addition of carbon nanotubes.

TABLE 2
Strength of Inks Comprising Crystalline
Polyester Resin Composites

| MWNT | Young's modulus | Hardness |
|---|---|---|
| (weight % of total ink weight) | (GPa) | (GPa) |
| 0 | 3.0 | 0.10 |
| 2 | 6.0 | 0.20 |
| 7 | 8.0 | 0.50 |

For ink applications that require increased electrical conductivity, such as, for example, RFID applications, the addition of MWNTs into the polymer chain can improve the electrical conductivity of the ink. Higher loadings of MWNTs, such as about 0.5 to about 20 weight % of the MWNT/polymer composite weight, are favorable to achieve the suitable conductivity that is resistive to change in temperature and it thus more thermally stable. Of course, amounts outside of this range may be employed.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. An ink comprising:
a carrier material;
a polymer matrix comprising functionalized carbon nanotubes dispersed in a polymer selected from the group consisting of polycarbonates, polyamides, polyesters, polyurethanes, polyethylenes, polyolefins, latex polymers, and mixture thereof, wherein at least some of the polymer is covalently attached to the carbon nanotubes;
one or more colorants; and
one or more waxes.

2. (canceled)

3. The ink according to claim 1, wherein the polymer is crystalline polymer, semi-crystalline polymer, or amorphous polymer.

4. The ink according to claim 1, wherein the polymer matrix comprises carbon nanotubes from about 0.5% to about 20% by weight of the polymer matrix.

5. The ink according to claim 1, wherein the polymer matrix comprises carbon nanotubes from about 1% to about 10% by weight of the polymer matrix.

6. (canceled)

7. The ink according to claim 1, wherein the ink is an inkjet ink.

8. The ink according to claim 1, wherein the polymer matrix is formed by a method comprising:
functionalizing carbon nanotubes;
covalently attaching a first monomer to the functionalized carbon nanotubes; and
polymerizing the first monomer with a second monomer to form a polymer matrix comprising carbon nanotubes.

9. The ink according to claim 1, wherein the ink has a Young's modulus from about 6.0 to about 8.0 GPa.

10. The ink according to claim 1, wherein the ink has a hardness from about 0.20 to about 0.50 GPa.

11. A method of making an ink, comprising:
functionalizing carbon nanotubes;
covalently attaching a first monomer to the functionalized carbon nanotubes, the first monomer being selected from the group consisting of diols having from 2 to 36 carbons, polyamines, aminocarboxylic acids, amino alcohols, and a mixtures thereof;
polymerizing the first monomer with an organic acid to form a polymer matrix comprising carbon nanotubes and a polymer selected from the group consisting of polycarbonates, polyamides, polyesters, polyurethanes, polyolefins, latex polymers, and mixtures thereof; and
adding one or more colorants and one or more waxes to the polymer matrix to form an ink.

12. (canceled)

13. The method according to claim 11, wherein:
the diol is selected from the group consisting of: 1,8-octanediol, 1,9-nonanediol, 1,10-decanediol, 1,11-undecanediol, 1,12-dodecanediol, and mixtures thereof.

14-15. (canceled)

16. An inkjet ink comprising:
a carrier material;
a crystalline polyester matrix comprising functionalized multi-walled carbon nanotubes dispersed in crystalline polyester so that at least some of the crystalline polyester is covalently linked to the carbon nanotubes;
one or more colorants; and
one or more waxes.

17. The inkjet ink according to claim 16, wherein the polymer matrix comprises carbon nanotubes from about 0.5% to about 20% by weight of the polymer matrix.

18. The inkjet ink according to claim 17, wherein the polymer matrix comprises carbon nanotubes from about 1% to about 10% by weight of the polymer matrix.

19. The inkjet ink according to claim 17, wherein the ink has a Young's modulus from about 6.0 to about 8.0 GPa.

20. The inkjet ink according to claim 17, wherein the ink has a hardness from about 0.20 to about 0.50 GPa.

21. The ink of claim 1, wherein the carbon nanotube content is from about 0.05 to about 5 wt % by weight of the carbon nanotube/polymer composite.

22. The ink of claim 1, wherein the carbon nanotube content is from about 2 to about 20 wt % by weight of the carbon nanotube/polymer composite.

23. The ink of claim 1, wherein the colorant is selected from the group consisting of carbon black, lamp black, iron black, ultramarine, Nigrosine dye, Aniline Blue, Du Pont Oil Red, Quinoline Yellow, Methylene Blue Chloride, Phthalocyanine Blue, Phthalocyanine Green, Rhodamine 6C Lake, Chrome Yellow, quinacridone, Benzidine Yellow, Malachite Green, Hansa Yellow G, Malachite Green hexalate, oil black, azo oil black, Rose Bengale, monoazo pigments, disazo pigments, trisazo pigments, tertiary ammonium salts, metallic salts of salicylic acid and salicylic acid derivatives, Fast Yellow G, Hansa Brilliant Yellow 5GX, Disazo Yellow AAA, Naphthol Red HFG, Lake Red C, Benzimidazolone Carmine HF3C, Dioxazine Violet, Benzimidazolone Brown HFR, Aniline Black, titanium oxide, Tartrazine Lake, Rhodamine 6G Lake, Methyl Violet Lake, Basic 6G Lake, Brilliant Green lakes, Hansa Yellow, Naphtol Yellow, Watching Red, Rhodamine B, Methylene Blue, Victoria Blue, and Ultramarine Blue.

24. The ink of claim 1, wherein the colorant is a dye, a mixture of pigment and dye, or a mixture of dyes.

25. The ink of claim 1, wherein:
the carrier material is present in an amount of about 20 to about 90 wt % of the ink;
the colorant is present in an amount of about 3 to about 20 wt % of the ink; and
the wax is present in an amount of about 0.1 to about 10 wt % of the ink.
